(19) United States
(12) Patent Application Publication
(10) Pub. No.: US 2026/0177049 A1
(43) Pub. Date: Jun. 25, 2026

(54) CAP FOR A FLUID SAMPLE DISPENSER

(71) Applicant: GARY KANE CONCEPT SAS, Paris (FR)

(72) Inventors: Arthur HAGIAGE, Paris (FR); Julia HAGIAGE, Paris (FR)

(73) Assignee: GARY KANE CONCEPT SAS, Paris (FR)

(21) Appl. No.: 19/126,055

(22) PCT Filed: Nov. 3, 2023
(86) PCT No.: PCT/EP2023/080650

§ 371 Date: Apr. 30, 2025

(30) Foreign Application Priority Data
Nov. 3, 2022 (FR) FR2211462

(51) Int. Cl. F04B 47/02

(52) U.S. Cl. CPC F04B 47/02

(57) ABSTRACT

The invention relates to a special cap for the dispensing of samples of more or less viscous fluids, such as cosmetics or food products. This cap comprises closure means for tight sealing of the container to which it is to be fixed, a motorised shaft comprising a longitudinal conduit and passing through the closure means and having a rotation axis perpendicular to the opening plane of the container, and to the end of which is fixed at least one blade, and a motor for actuating the rotation of the shaft. The conduit of a dispensing pump can be inserted into the shaft and the actuation of the blades moves the product back towards the centre and prevents air from being pumped.

The invention relates, in general, to the dispensing of samples of more or less viscous fluids, such as cosmetics or even food products.

Traditionally, perfume and cosmetics shops offer their customers the opportunity to try out various products, ranging from perfumes, which are very liquid, to creams, which are much more viscous. Typically, a commercial container of the product is unpacked and left for self-service. Each customer can handle it as they see fit, which can cause several problems. Firstly, there is a hygiene issue, as all customers handle the item freely and may spill product on the display cases. Secondly, there is also the problem of waste, as the drawn quantities cannot be controlled and the product remaining at the bottom of the jars often remains unused. The product is systematically changed even when about 30% still remains. There is also a space issue, as samples are often placed on fairly large trays in front of the shelves.

Many of these products are packaged in bottles sealed with a metering pump system, also known as a cosmetic pump or dispenser pump. The operating principle of these pumps is well known. A circuit (a pipe) connects the pump's dispensing outlet located in the pump head to the inside of the bottle, usually the bottom of the bottle. A chamber is inserted into the pump head, closed at the bottom by a ball valve that allows fluid to flow in this circuit in one direction only, towards the outlet. When the pump head is pressed, the pressure pushes against the ball that seals the circuit. At the same time, the volume of the chamber is reduced, forcing its contents to be discharged towards the pump outlet. When the pressure is released, the vacuum lifts the ball and fluid is drawn from the bottle into the chamber, which returns to its original volume. The pump head serves as both a cap and a means of dispensing the product. This cap must seal the bottle in an airtight manner.

However, this system is not suitable for all products, particularly viscous products such as certain creams, which are instead distributed in jars with screw-on “lids” that are several centimetres in diameter. During the suction phase with the metering pump, if the viscosity is too high, a vacuum forms at the base of the pipe at the bottom of the bottle, and during the next suction, air is sucked in, creating bubbles in the system. The quantity dispensed each time the pump is pressed thus becomes random, or even zero, because after a few presses, the product in the circuit is completely replaced by air.

The applicant therefore deemed it necessary to develop a dispenser suitable for these products, allowing the dispensing of the product to be controlled or even automated with a metering pump system, and taking up very little space.

To this end, the invention relates to a cap for a container comprising:
closure means for tight sealing of the container,
A motorised shaft comprising a longitudinal conduit passing through the closure means and having a rotation axis perpendicular to the opening plane of the container, and at the end of which at least one blade is fixed, and
A motor for actuating the rotation of the shaft.

A cap for a container refers here broadly to both a cap for a bottle neck and a lid for a jar, without limitation as to its diameter. The cap comprises means for securing it to a container, which may, for example, comprise threading complementary to a thread on the container, and/or clamps for gripping the container or means for clipping onto the container.

The closure means for tight sealing of the container refer to means for preventing the circulation of air and other fluids between the interior and exterior of the container other than via the longitudinal conduit included in the shaft. This is important for preserving the product stored in the container. The closure means for tight sealing are designed to cover the opening of the container and are therefore generally disc-shaped, with a diameter that is approximately the same as the opening of the container. The closure means for tight sealing may comprise a gasket (to be placed around the opening of the container), a disc, a spring (to allow adjustment of contact between two parts), etc.

The motorised shaft is arranged to pass through the closure means for tight sealing. Part of the shaft is therefore designed to be inserted into the container, with the other part protruding from the cap on the other side. Its rotation axis is perpendicular to the opening plane of the container and therefore, by extension, to the closure means for tight sealing which are intended to be arranged in the opening plane of the container to ensure tightness.

At least one blade, preferably between two and four blades, and more preferably two blades, is/are attached to the end of the shaft. The blades are designed to rotate against the bottom of the container. They are therefore preferably arranged substantially perpendicular to the rotation axis of the shaft, i.e. horizontally in operational mode. Their shape can be adjusted to fit the bottom of the container.

Preferably, the motorised shaft is arranged so that it can move along its axis through the closure means for tight sealing. This allows the length of the shaft to be easily adjusted to suit the size of the container, so that the blades reach the bottom of the container.

The shaft can be rotated by a motor, preferably housed on the external part of the cap and coupled to the shaft. This is an electric motor that can be battery-powered, with the battery also contained in the cap, or include a connection port for a power source.

The electric motor can operate intermittently or continuously. Preferably, the motor operates intermittently, and more preferably intermittently after the product is dispensed.

When the shaft is activated, the blades rotate to displace the contents at the bottom of the container towards the centre in order to overcome the problem of air pockets forming after material is removed from the container, and thus prevent the formation of bubbles in a distribution circuit of a metering pump that may be coupled to the cap of the invention.

The rotation axis of the shaft is preferably centred in relation to the container (and the closure means) to allow rotation.

Furthermore, the shaft comprises a longitudinal conduit to allow insertion of the pick up pipe of a metering pump. The longitudinal conduit may include a sealing gasket for the container when a pick up pipe from a metering pump is inserted into it.

The cap may consist of one or more parts. When the cap consists of several parts, they can be assembled by any means of airtight assembly. When the cap consists of several parts, these may include, for example, the shaft with its blades, a part supporting the motor, and an adapter part on the container. This makes it easy to manufacture the shaft and motor part in a standardised manner and to supply a variety of (less expensive) adapter parts to easily vary the products.

The invention therefore also relates to the assembly comprising:
the cap of the invention, and
a metering pump comprising a dispensing piston with a chamber and a non-return valve, connected to a pick up pipe,

The pick up pipe being inserted into the longitudinal conduit of the cap.

In a preferred embodiment, the shaft actuating motor is arranged to be actuated synchronously with the actuation of the pump's dispensing piston. This means that the shaft motor only operates intermittently, when product is being drawn from the container, in order to re-homogenise the contents at the bottom of the container before the next time the product is drawn.

Advantageously, for this purpose, the dispensing pump can also be motorised, and the dispensing motor is then synchronised with the shaft actuating motor. In this case, a power supply is provided for the dispensing motor, for example a battery or a mains connection. There are several ways, known to the skilled person, of motorising such a pump. For example, the movement of the piston can be motorised and/or the movement of the chamber can be motorised.

The metering pump can also include a sensor coupled to the motor of the dispensing piston. The sensor is, for example, a pressure detector (such as a button that is pressed), a motion detector or a presence detector that detects, for example, the passage or presence of a hand or object under the dispensing piston.

Installed in a shop, the metering pump can be more or less distant from the cap of the invention and the container on which it is fitted, such the pick up pipe is longer than traditionally. This means, for example, that several metering pumps can be grouped together in a small space, while the caps and containers can be placed further back in a closed cabinet in space-optimised positions.

If each metering pump is fitted with a sensor, the user can then select the product they wish to test by passing their hand or an object under the corresponding metering pump (identified, for example, by a suitable label or any other means of identification). An indicator light can be added to confirm which metering pump is dispensing the product.

Generally speaking, the airtightness of the pump-cap-container assembly is important for the correct operation of the sample dispenser and to ensure compliance of the microbiology of the products.

Another important parameter is the compatibility of the materials of the parts intended to be in contact with the products themselves, to ensure that there is no contamination of the products. The person skilled in the art will be able to identify the appropriate materials, depending on the use.

Generic materials that can be used in cosmetics, for example for the shaft and blades of the cap, include nitrile (FDA Nitrile), Teflon (PTFE), a PP/PE blend or stainless steel. They can also be materials such as Trea-Seal® marketed by Tekniplex.

The cap of the invention can be used for any type of sample dispensing for product trials, and in particular for products requiring special hygiene standards for handling, such as cosmetic products (creams, make-up, etc.) and food products (oils, yoghurts, dessert creams, drinks, alcohols, syrups, etc.). It is primarily intended for use in any place where a product demonstration is required, such as shops, offices, events, trade fairs or exhibitions, or in public places such as stations, airports or outdoor areas.

It allows handling products with a certain viscosity that previously could not be used with metering pumps, such as creams or emulsions.

The invention will be better understood with the aid of the description of several embodiments, corresponding to the drawing in which:

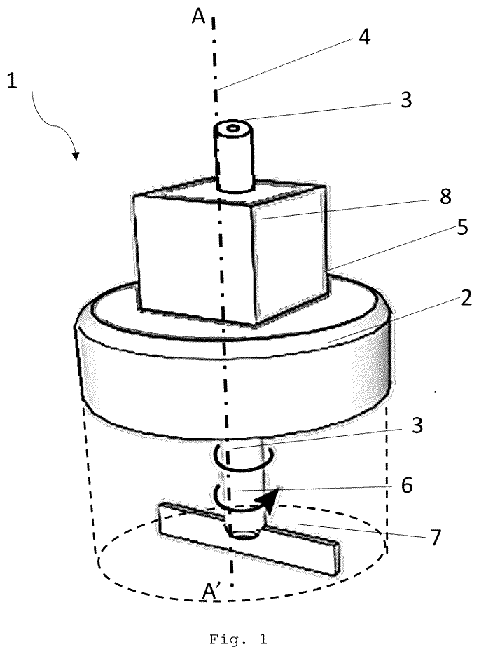

FIG. 1 shows a perspective view of a cap according to the invention;

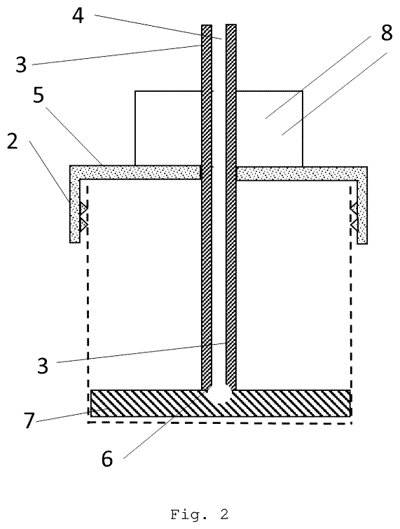

FIG. 2 is a cross-sectional view of the cap in FIG. 1;

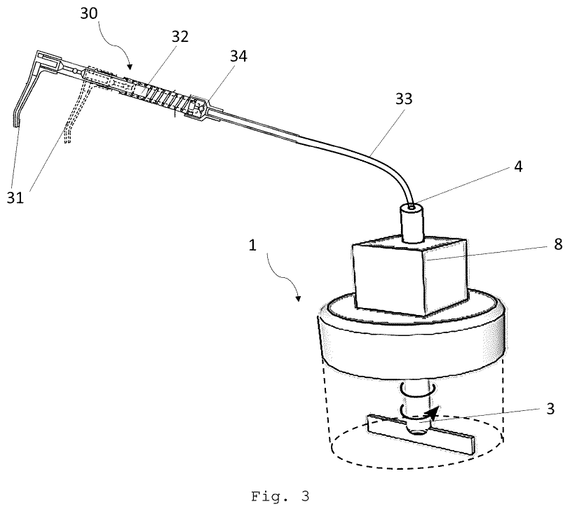

FIG. 3 illustrates a pump-cap assembly of the invention;

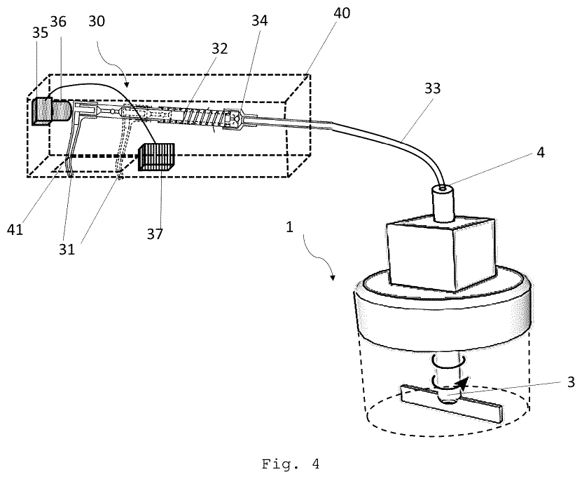

FIG. 4 illustrates another embodiment of a pump-cap assembly according to the invention.

With reference to FIGS. 1 and 2, a cap 1 for a container (shown as a dotted line) according to the invention comprises closure means 2 for tight sealing of the container, in this case a lid that can be screwed onto a container. A motorised shaft 3 passes through the lid 2. A longitudinal conduit 4 extends through the centre of the shaft, along its entire length. The axis of the shaft AA′ also corresponds to its rotation axis, which is perpendicular to the opening plane of the container, i.e. in this case to the surface 5 of the lid. The lower end 6 of the shaft is designed to penetrate into the container. At this end is a blade 7, which can be considered as a double blade. The longitudinal conduit 4 running through the shaft opens out here at the centre of the blade. A motor 8 is housed in a protected compartment on the top part of the cap. It is designed to rotate the shaft 3, in a manner well known to a person skilled in the art.

The cap 1 is screwed onto the container in an airtight manner. Although not the case here, a ring gasket could additionally be wedged between the cap and the edges of the opening to ensure airtightness.

The shaft 3 can slide through the lid here, such that its length in the container allows it to reach the bottom of the container. However, this feature is optional, and the shaft could be fixed, for example if the container used is always the same.

A flat double blade is shown here at the end of the shaft, but the number and shape of the blade(s) may be different. The blades can be inclined or curved, for example, and their shape can be adapted according to the viscosity of the product to be dispensed, the size of the container (its width as well as its depth), etc. The blades can be rigid or flexible.

The cap is shown here assembled in one piece, but it could also be in several pieces: for example, the surface 5 of the lid could have an opening and a thread, the motor unit could have a complementary threading and be screwed onto the lid, the shaft could then be inserted from below, or the shaft 3 could be pre-assembled with the motor 8. This flexibility of the cap means, for example, that only the lid and shaft need to be changed when the product or batch of product in the container is changed, and that the motor unit, which is the most expensive to produce, can be retained.

With reference to FIG. 3, the cap 1 is combined with a relatively conventional metering pump p 30. It comprises a dispensing piston 31, which can move between a rest position (solid line) and a dispensing position (dotted line). A chamber 32 is present under the piston, the volume of this chamber varying according to the position of the piston. A pick up pipe 33, or hose, extends from the chamber. It is inserted into the longitudinal conduit 4 of the shaft 3 of the cap 1, up to the opening at the level of the blades. A gasket can be provided in the longitudinal conduit to ensure that the system is airtight when the pipe is inserted. A non-return valve 34, in this case a ball valve, is inserted between the chamber 32 and the pipe 33.

The valve is designed such that, when pressure is applied to the dispensing piston 31, it is closed and the fluid contained in the chamber, the volume of which decreases, discharges towards the outlet of the piston 30, and, when the pressure is released, the valve 34 opens and fluid rising in the pipe 33 fills the chamber 32, the volume of which increases.

It may be possible to link the dispensing piston to a sensor connected to a control unit for the shaft actuating motor 8. In this way, pressing the dispensing piston could trigger the motor and the rotation of the blades. Hence, when fluid is drawn from the container, it is homogenised to prevent the formation of air in the pipe 33.

In a particular embodiment, illustrated in FIG. 4, a dispensing pump, such as pump 30, is installed in a casing 40 (shown as dotted lines) having an opening 41 at the outlet of the dispensing piston 31. A motor 35 driving a piston 36 is installed inside the housing such that the piston 36 is placed in contact with the dispensing piston 31. A sensor 37, in this case a motion detector for example, is positioned in the casing in an opening present close to the opening 41. The sensor 37 can therefore detect movement outside the casing, close to the dispensing nozzle. The sensor 37 is connected to the motor 35, and an integrated circuit associates the detection of a movement by the sensor 37 with the activation of the motor 35, which causes the piston 36 to move and press on the dispensing piston 31 to dispense the fluid. Advantageously, the motor 35 is synchronised with the motor 8 for actuating shaft 3.

This is just one example of how the metering pump can be automated. Firstly, the dispensing piston can have shapes other than that shown, and other means of actuation can be envisaged, either external (part not physically connected) to the dispensing pump as such, or as an integral part (part inserted into the metering pump) for the metering pump. Similarly, the electrical connections are not shown here, as there are many possibilities well known to a person skilled in the art.

A casing such as the casing 40 shown in FIG. 4, or any other type of casing, protects the metering pump mechanism and facilitates the juxtaposition of multiple metering pumps. This is particularly useful in a shop, to save space. Such casings can, for example, be fixed under shelves or in a cabinet, so that the user does not need to see the mechanism of either the pump or the cap.

A cap that can be screwed onto the container is illustrated here. However, the means of securing the cap to the container can be varied. For example, it could be a cap that fits hermetically into the opening of the container, or a spring-loaded or clamped jaw with at least two lugs or jaws that grip the container. In addition to the lugs, for example, a gasket disc of the same diameter as the container opening can be provided to ensure airtightness, for example with a spring to ensure it is pressed tightly against the container opening. This type of fastening can allow a degree of flexibility in the diameter of the container opening.

1. A cap for a container comprising:
closure means for tight sealing of the container,
a motorised shaft comprising a longitudinal conduit passing through the closure means and having a rotation axis perpendicular to the opening plane of the container, and at the end of which at least one blade is fixed, and
a motor for actuating the rotation of the shaft.

2. A cap according to claim 1, further comprising means for attaching to said container.

3. A cap according to claim 1, wherein the motorised shaft is configured to be movable along its axis through the closure means.

4. A cap according to claim 1, comprising between two and four blades.

5. A cap according to claim 1, in which the blades are arranged substantially perpendicular to the rotation axis of the shaft.

6. A cap according to claim 1, wherein the longitudinal conduit comprises a sealing gasket.

7. A cap according to claim 1, comprising several parts.

8. Assembly formed by:
the cap according to claim 1, and
a metering pump comprising a dispensing piston with a chamber and a non-return valve, connected to a pick up pipe,
the pick up pipe being inserted into the longitudinal conduit of the cap.

9. Assembly according to claim 8, wherein the motor for actuating the shaft is configured to be actuated synchronously with the actuation of the pump's dispensing piston.

10. Assembly according to claim 8, wherein the metering pump is also motorised, and the motor for actuating is then synchronised with the motor for actuating the shaft.

11. Assembly according to claim 8, wherein the metering pump comprises a sensor coupled to the motor of the dispensing piston.
